(19) United States
(12) Patent Application Publication
(10) Pub. No.: US 2025/0388470 A1
(43) Pub. Date: Dec. 25, 2025

(54) METHOD FOR STRUCTURAL AND CHEMICAL REGULATION OF ANODE CARBON MATERIALS OF RATE-TYPE SODIUM-ION BATTERY AND APPLICATION THEREOF

(71) Applicant: Beijing University Of Chemical Technology, Beijing (CN)

(72) Inventors: Jieshan Qiu, Beijing (CN); Qi Yang, Beijing (CN)

(21) Appl. No.: 18/822,114

(22) Filed: Aug. 31, 2024

(30) Foreign Application Priority Data
Jun. 20, 2024 (CN) 2024107990345

(51) Int. Cl. C01B 32/05; H01M 10/054

(52) U.S. Cl. CPC C01B 32/05; H01M 10/054; C01P 2004/03; C01P 2006/40

(57) ABSTRACT

A method for structural and chemical regulation of anode carbon materials of rate-type sodium-ion battery and an application thereof utilize active gas to etch and dope a carbon material at a certain temperature. The etching reflects a reaction between the active gas and carbon atoms. This process is accompanied by the introduction of non-carbon heteroatoms, thereby obtaining anode carbon materials of sodium-ion battery. The method utilizes active gases for etching to construct rich porous structures, and the introduction of heteroatoms such as N, O, and S can regulate surface chemical properties of the carbon material. Through synergistic effects of the porous structure and surface chemistry (atomic doping), the carbon material achieves a high sodium storage capacity of 388.97 mAh g⁻¹, and under the condition of a high current density of 1 A g⁻¹, it exhibits an ultra-high specific capacity of about 340 mAh g⁻¹, while also showing excellent cycling stability.

### TECHNICAL FIELD

The disclosure relates to the technical field of anode carbon materials of sodium-ion batteries, and particularly to a method for structural and chemical regulation of an anode carbon material of a rate-type sodium-ion battery (also referred to as high-rate sodium-ion battery) and an application thereof.

### BACKGROUND

Solar and wind energy, as clean and renewable sources, exhibit drawbacks such as intermittency and regionality, which needs the development of large-scale energy storage technologies for the storage and transportation of energy. Among the various secondary battery technologies, sodium-ion batteries share similar electrochemical working principles with lithium-ion batteries, where charge carriers are intercalated or deintercalated from the anode and cathode materials, thus the basic research on sodium-ion batteries has developed rapidly. Moreover, sodium-ion batteries have industrial advantages such as abundant sodium reserves, low cost, high safety, good rate performance, and excellent low-temperature performance, demonstrating a huge application prospect in the field of large-scale energy storage. Anode materials are one of the core components of sodium-ion batteries, and their properties directly affect the overall electrochemical performance of the batteries. Among the many developed anode materials, carbon materials are widely concerned due to their high conductivity, good structural and chemical stability, and ease of large-scale preparation. In particular, hard carbon materials, with their high capacity and low operating voltage, have become a hot topic and frontier in the research field of the anode materials for the sodium-ion batteries.

Coal has a series of advantages such as high carbon content, low cost, and abundant reserves, making it an excellent precursor for the preparation of carbon materials. The organic matter in coal mainly exhibits properties of aromatic hydrocarbons at the molecular chemical level. Direct simple thermal treatment for coal is prone to form carbon materials with high graphitization degree due to π-π interactions, and its smaller graphite layer spacing is not conducive to the efficient storage of large sodium ions. In addition, the volatile components from the coal will introduce pore structures into the carbon materials, which will affect the sodium storage of the carbon materials. Phenolic resin has the advantage of low ash content and is one of the excellent raw materials for preparing high-quality carbon materials. Coconut shells, as a low-cost and widely available biomass material, after carbonization, have a rich and well-developed pore structure, mainly composed of micropores and macropores, with some mesopores. However, the larger pore structure is not conducive to sodium ion storage, so simple and effective methods are needed to modify their surfaces and structures to improve their sodium storage capacity.

### SUMMARY

To overcome the shortcomings in related art, the disclosure aims to provide a method for preparing carbon materials for sodium-ion batteries that is low-cost, scalable, and features a rich porous structure and surface heteroatom doping. By utilizing the advantages of phenolic resin, such as low ash content and clear chemical composition, coal and phenolic resin are used to produce high-performance carbon materials, thereby achieving excellent sodium-ion battery performance.

To achieve the above objectives of the disclosure and to address the issues in related art, the technical scheme of the disclosure is realized by providing a method for structural and chemical regulation of anode carbon materials of rate-type sodium-ion battery, which includes steps as follows.
S1, a raw material is crushed and ground, and then the raw material is subjected to a first stage of thermal treatment to remove the volatiles, thereby obtaining a precursor primary carbide product.
S2, the precursor primary carbide product is subjected to a second stage of thermal treatment in an active gas atmosphere, thereby obtaining a carbon material with structural etching and surface chemical modification.
S3, under an inert atmosphere, the carbon materials obtained in the step (2) are further subjected to a third stage of thermal treatment, which includes the regulation of the microstructure and conductivity of the carbon materials, ultimately obtaining the anode carbon material of rate-type sodium-ion battery.

Specifically, the S1 further includes: taking a raw material, crushing and grinding the raw material to obtain precursor powder, followed by placing the precursor powder in a corundum boat and place the corundum boat added with the precursor powder in a tube furnace, and then pre-passing a protective gas to exhaust air in a tube furnace; under a protection of the protective gas, performing carbonization on the precursor powder at a temperature in a range of 500-900° C. to obtain a precursor primary carbide product.

In an embodiment, the raw material includes one or more selected from the group consisting of coal, coal tar pitch, coal tar, pitch coke, needle coke, phenolic resin, and coconut shells.

The S2 further includes: after obtaining the primary carbonization precursor product, replacing the protective gas with an active gas, and using the active gas to etch and doping modify the precursor primary carbide product at a temperature in a range of 600-900° C. to obtain a carbon material with structural etching and surface chemical modification.

The S3 further includes: after obtaining the carbon material with structural etching and surface chemical modification, replacing the active gas with a protective gas, performing carbonization on the carbon material with structural etching and surface chemical modification at a temperature in a range of 1000-1800° C. to obtain the anode carbon material of the rate-type sodium-ion battery.

In an embodiment, the protective gas is nitrogen or argon.

In an embodiment, the active gas is a single active gas,, and the active gas comprises one or more selected from the group consisting of ammonia (NH₃), water vapor, carbon dioxide (CO₂), and hydrogen sulfide (H₂S); a mixture gas of an active gas and an inert gas; or the active gas includes one or more selected from the group consisting of NH₃, water vapor, CO₂, and H₂S.

In an embodiment, a ratio of flow rates of the active gas to the inert gas is in a range of 1: (0-10), and a total flow rate of the mixture gas is in a range of 20-100 milliliters per minute (mL min⁻¹).

In the S1-S3, the first stage of thermal treatment is conducted at a temperature in a range of 500-900° C., the second stage of thermal treatment is at a temperature in a range of 600-900° C., the third stage of thermal treatment is at a temperature in a range of 1000-1800° C., and a heating rate is in a range of 1-10° C. per minute (° C. min⁻¹).

The disclosure also provides a half-battery prepared using the carbon material, which includes steps as follows.
Anode Preparation: 40 milligrams (mg) of the anode carbon material, 5 mg of conductive carbon black, and 5 mg of sodium carboxymethyl cellulose (CMC) are ground in a mortar for 15 minutes. Then, 500 microliters (μL) of deionized water are added into the mortar, and followed by grounding for 6 minutes to obtain a uniform slurry. The slurry is evenly coated on the surface of a copper foil with a spatula and vacuum dried at 120° C. for 12 hours to obtain the anode sheet.
Assembly: in a glove box filled with the inert gas of argon atmosphere, the components are stack in the following order: cathode casing, cathode electrode (sodium sheet), glass fiber separator, electrolyte, anode sheet, gasket, spring clip, and anode casing. the assembly is sealed using a scaling machine. The electrolyte is prepared using sodium hexafluorophosphate (NaPF₆) as a solute and ethylene glycol dimethyl ether (DME) as a solvent, with a concentration of 1 mol per liter (mol L⁻¹), to complete the battery assembly.
Testing: a battery testing system is a blue electric battery testing system, with a voltage window of 0.001 to 3 voltages (V) for the tests.

The beneficial effects of the disclosure are as follows.

The disclosure utilizes a series of active gases containing the heteroatoms such as nitrogen (N), oxygen (O), and sulfur(S) to etch and dope the carbon materials, creating a rich porous structure while the introduction of N, O, S, and other heteroatoms regulates the surface chemical properties of the carbon materials. Through the synergistic effect of structure and surface chemical properties, the carbon materials achieve a high sodium storage capacity of 388.97 milliampere-hours per gram (mAh g⁻¹), with a coulombic efficiency of over 90%. At a high current density of 1 ampere per gram (A g⁻¹), after 200 cycles, the discharge specific capacity is around 300 mAh g⁻¹, demonstrating excellent rate performance and cycling stability. Among similar methods for processing precursor materials, the method provided by the disclosure for preparing hard carbon anode material for rate-type sodium-ion battery is simpler and easier to operate, meeting the needs of large-scale industrial production, while also having superior electrochemical performance.

### BRIEF DESCRIPTION OF DRAWINGS

FIG. 1 illustrates an initial charge-discharge curve of a hard carbon anode material of a sodium ion battery prepared in an embodiment 1 at a current density of 50 mA g⁻¹.

FIG. 2 illustrates cyclic performance test results of a half-battery assembled with the hard carbon anode material of the sodium ion battery prepared in the embodiment 1 at a current density of 1 A g⁻¹.

FIG. 3 illustrates an initial charge-discharge curve of a hard carbon anode material of a sodium ion battery prepared in an embodiment 2 at a current density of 50 mA g⁻¹.

FIG. 4 illustrates cyclic performance test results of the hard carbon anode material of the sodium ion battery prepared in the embodiment 2 at a current density of 1 A g⁻¹.

FIG. 5 illustrates an initial charge-discharge curve of a hard carbon anode material of a sodium ion battery prepared in an embodiment 3 at a current density of 50 mA g⁻¹.

FIG. 6 illustrates cyclic performance test results of a half-battery assembled with the hard carbon anode material of the sodium ion battery prepared in the embodiment 3 at a current density of 0.05 A g⁻¹.

FIG. 7 illustrates rate performance test results of the half-battery assembled with the hard carbon anode material of the sodium ion battery prepared in the embodiment 3.

FIG. 8 illustrates a scanning electron microscope (SEM) image of the hard carbon anode material of the sodium ion battery prepared in the embodiment 3.

FIG. 9 illustrates an initial charge-discharge curve of a hard carbon anode material of a sodium ion battery prepared in a comparative example at a current density of 50 mA g⁻¹.

FIG. 10 illustrates cyclic performance test results of the hard carbon anode material of the sodium ion battery prepared in the embodiment 2 at a current density of 1 A g⁻¹.

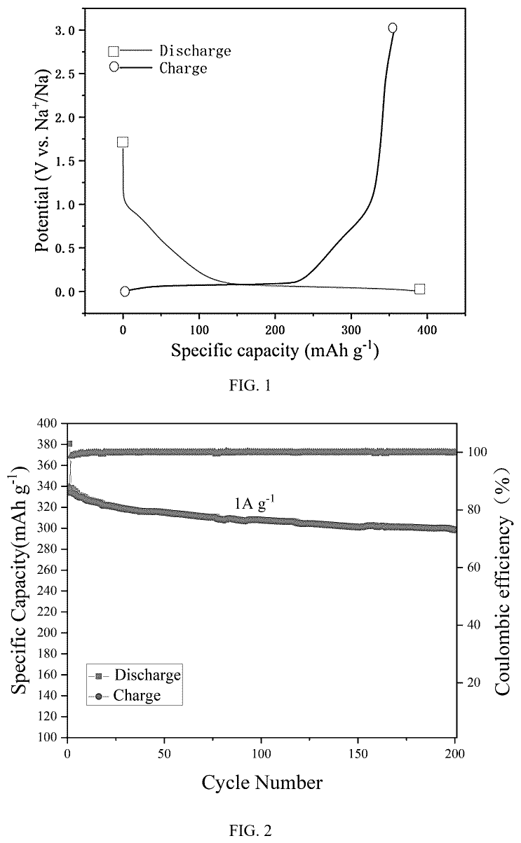

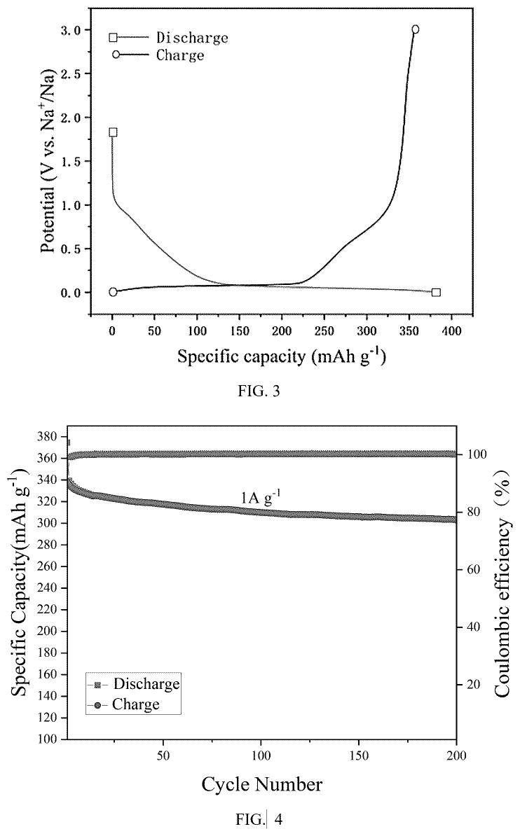

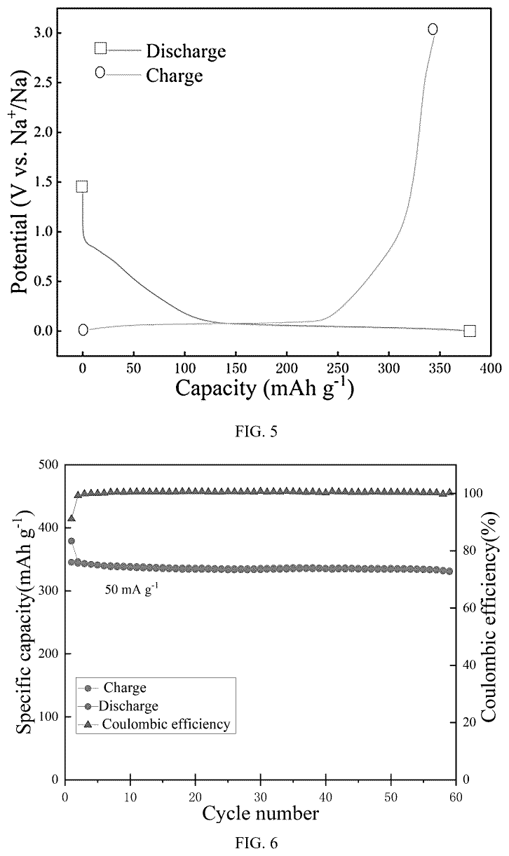

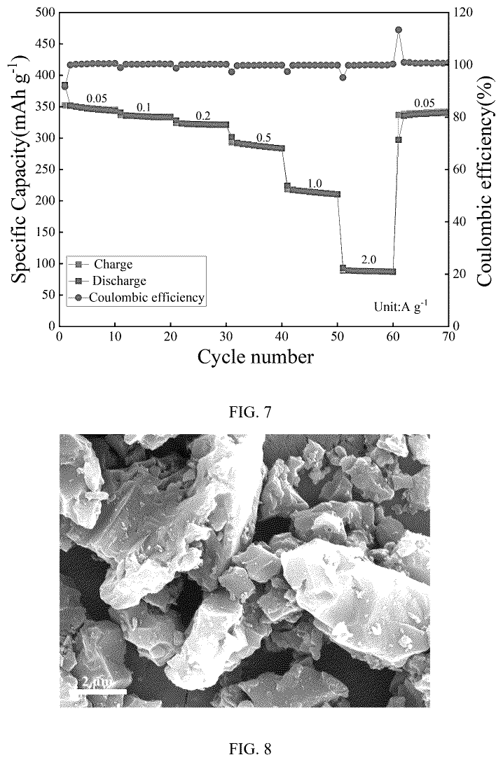

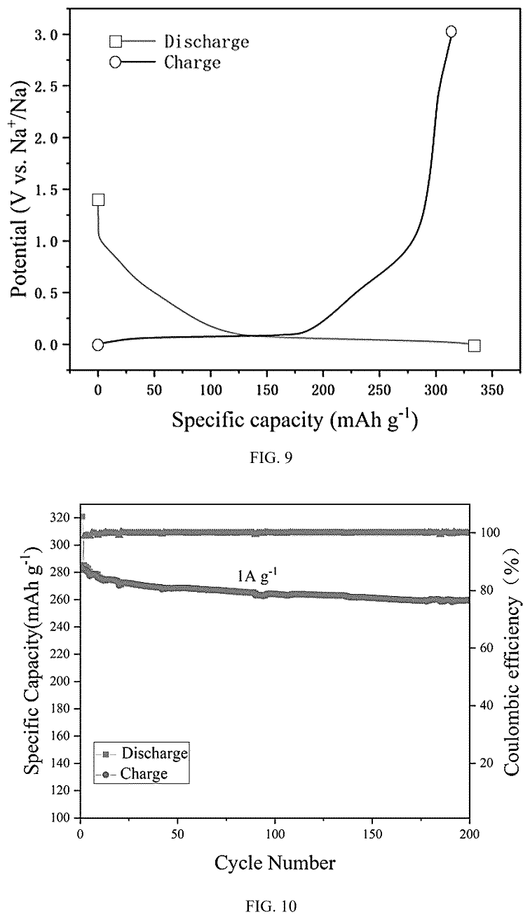

### DETAILED DESCRIPTION OF EMBODIMENTS

The disclosure will be further explained in conjunction with the embodiments.

### Embodiment 1

(1) Phenolic resin is taken for crushing and grinding to obtain precursor powder, followed by placing the precursor powder in a corundum boat, and the corundum boat added with the precursor powder is placed in a center of a tube furnace, and then argon gas is pre-passed for 30 min to exhaust air in the tube furnace. Under a protection of the argon gas, carbonization is performed on the precursor powder by raising a temperature from room temperature to 700° C. at a heating rate of 5° C. min⁻¹ and holding the raised temperature for 2 hours (h), thereby to obtain a precursor primary carbide product.
(2) After obtaining the primary carbonization precursor product, deionized water is added into a three-neck flask and heat the deionized water using an electric heating jacket to obtain water vapor as an active gas, the argon gas is replaced with the water vapor. The water vapor is then used to etch and dope the precursor primary carbide product at a temperature raised from room temperature at a heating rate of 5° C. min⁻¹ up to 800° C., with a gas flow rate of 20 mL min⁻¹, and the raised temperature is held for 2 h to obtain a carbon material with structural etching and surface chemical modification.
(3) After obtaining the carbon material with structural etching and surface chemical modification, the water vapor is replaced with the argon gas. Under a protection of the argon gas, the carbonization is performed on the carbon material with structural etching and surface chemical modification obtained from the step 2 at a temperature raised from room temperature at a heating rate of 5° C. min⁻¹ up to 1300° C., and the raised temperature is held for 2 h, thereby to obtain the anode carbon material of the rate-type sodium-ion battery.

In the embodiment 1, the electrochemical performance of the sodium-ion battery hard carbon anode material prepared is as follows. At a current density of 50 mA g⁻¹, its initial discharge specific capacity can reach 388.97 mAh g⁻¹, with a platform capacity below 0.1 V of 252.97 mAh g⁻¹, and a coulombic efficiency of 91.61%. At a high current density of 1 A g⁻¹, after 200 cycles, it still has a discharge specific capacity of 298.89 mAh g⁻¹, demonstrating good electrochemical performance.

### Embodiment 2

(1) Phenolic resin is taken for crushing and grinding to obtain precursor powder, followed by placing the precursor powder in a corundum boat, and the corundum boat added with the precursor powder is placed in a center of a tube furnace, and then argon gas is pre-passed for 30 min to exhaust air in the tube furnace. Under a protection of the argon gas, carbonization is performed on the precursor powder by raising a temperature from room temperature to 700° C. at a heating rate of 5° C. min⁻¹ and holding the raised temperature for 2 h, thereby to obtain a precursor primary carbide product.
(2) After obtaining the primary carbonization precursor product, the argon gas is replaced with NH₃ gas. The NH₃ gas is then used to etch and dope the precursor primary carbide product at a temperature raised from room temperature at a heating rate of 5° C. min⁻¹ up to 700° C., with a gas flow rate of 20 mL min⁻¹, and the raised temperature is held for 2 h to obtain a carbon material with structural etching and surface chemical modification.
(3) After obtaining the carbon material with structural etching and surface chemical modification, the NH₃ gas is replaced with the argon gas. Under a protection of the argon gas, the carbonization is performed on the carbon material with structural etching and surface chemical modification obtained from the step 2 at a temperature raised from room temperature at a heating rate of 5° C. min⁻¹ up to 1300° C., and the raised temperature is held for 2 h, thereby to obtain the anode carbon material of the rate-type sodium-ion battery.

In the embodiment 2, the electrochemical performance of the sodium-ion battery hard carbon anode material prepared is as follows. At a current density of 50 mA g⁻¹, its initial discharge specific capacity can reach 381.27 mAh g⁻¹, with a platform capacity below 0.1 V of 253.89 mAh g⁻¹, and a coulombic efficiency of 93.32%. At a high current density of 1 A g⁻¹, after 200 cycles, it still has a discharge specific capacity of 303.17 mAh g⁻¹, demonstrating good electrochemical performance.

### Embodiment 3

(1) Phenolic resin is taken for crushing and grinding to obtain precursor powder, followed by placing the precursor powder in a corundum boat, and the corundum boat added with the precursor powder is placed in a center of a tube furnace, and then argon gas is pre-passed for 30 min, with a flow rate of 5 L min⁻¹ to exhaust air in the tube furnace. Under a protection of the argon gas, carbonization is performed on the precursor powder by raising a temperature from room temperature to 700° C. at a heating rate of 5° C. min⁻¹ and holding the raised temperature for 2 h, thereby to obtain a precursor primary carbide product.
(2) After obtaining the primary carbonization precursor product, the argon gas is replaced with CO₂ gas. The CO₂ gas is then used to etch and dope the precursor primary carbide product at a temperature raised from 700° C. at a heating rate of 5° C. min⁻¹ up to 800° C., with a gas flow rate of 20 mL min⁻¹, and the raised temperature is held for 2 h to obtain a carbon material with structural etching and surface chemical modification.
(3) After obtaining the carbon material with structural etching and surface chemical modification, the CO₂ gas is replaced with the argon gas. Under a protection of the argon gas, the carbonization is performed on the carbon material with structural etching and surface chemical modification obtained from the step 2 at a temperature raised from 800° C. at a heating rate of 5° C. min⁻¹ up to 1300° C., and the raised temperature is held for 2 h, thereby to obtain the anode carbon material of the rate-type sodium-ion battery.

In the embodiment 3, the electrochemical performance of the sodium-ion battery hard carbon anode material prepared is as follows. At a current density of 50 mA g⁻¹, its initial discharge specific capacity can reach 379.04 mAh g⁻¹, and a coulombic efficiency is 91.11%.

### Comparative Example

(1) Phenolic resin is taken for crushing and grinding to obtain precursor powder, followed by placing the precursor powder in a corundum boat, and the corundum boat added with the precursor powder is placed in a center of a tube furnace, and then argon gas is pre-passed for 30 min to exhaust air in the tube furnace. Under a protection of the argon gas, carbonization is performed on the precursor powder by raising a temperature from room temperature to 700° C. at a heating rate of 5° C. min⁻¹ and holding the raised temperature for 2 h, thereby to obtain a precursor primary carbide product.
(2) After obtaining the primary carbonization precursor product, a thermal treatment is performed on the precursor primary carbide product at a temperature raised from room temperature at a heating rate of 5° C. min⁻¹ up to 800° C., with a gas flow rate of 20 mL min⁻¹, and the raised temperature is held for 2 h, followed by continuing to perform a high-temperature carbonization at the temperature raised from 800° C. at a heating rate of 5° C. min⁻¹ up to 1300° C., and holding the raised temperature for 2 h, thereby to obtain the anode carbon material of the rate-type sodium-ion battery.

In the comparative example, the electrochemical performance of the sodium-ion battery hard anode carbon material prepared is as follows. At a current density of 50 mA g⁻¹, its initial discharge specific capacity can reach 332.77 mAh g⁻¹, with a platform capacity below 0.1 V of 209.11 mAh g⁻¹, and a coulombic efficiency of 94.40%. At a high current density of 1 A g⁻¹, after 200 cycles, it still has a discharge specific capacity of 259.68 mAh g⁻¹, demonstrating good electrochemical performance. Compared to the comparative example, the initial discharge specific capacity in the embodiments 1-2 is nearly 50 mAh g⁻¹ higher. The platform capacity below 0.1 V, as an important indicator for measuring the performance of hard anodes carbon, has also significantly increased. Moreover, after 200 cycles at a high current density of 1 mA g⁻¹, the discharge specific capacity of the embodiments 1-2 is still much higher than that of the comparative example. Therefore, after the structural etching by the active gas and surface chemical modification as described above, the electrochemical performance of the precursor can be significantly improved.

Although several embodiments of the disclosure have been presented, those skilled in the art should understand that changes can be made to the embodiments without departing from the spirit of the disclosure. The above embodiments are only exemplary and should not be used as a limitation on the scope of the disclosure.

What is claimed is:

1. A method for preparing an anode carbon material for a rate-type sodium-ion battery, comprising:
S1, taking a raw material, crushing and grinding the raw material to obtain precursor powder, followed by placing the precursor powder in a corundum boat and placing the corundum boat added with the precursor powder in a tube furnace, and then pre-passing a protective gas to exhaust air in the tube furnace;
under a protection of the protective gas, performing carbonization on the precursor powder at a temperature in a range of 500-900° C. to obtain a precursor primary carbide product;
S2, after obtaining the primary carbonization precursor product, replacing the protective gas with an active gas, and using the active gas to etch and doping modify the precursor primary carbide product at a temperature in a range of 600-900° C. to obtain a carbon material with structural etching and surface chemical modification; and
S3, after obtaining the carbon material with structural etching and surface chemical modification, replacing the active gas with the protective gas, performing carbonization on the carbon material with structural etching and surface chemical modification at a temperature in a range of 1000-1800° C. to obtain the anode carbon material of the rate-type sodium-ion battery.

2. The method as claimed in claim 1, wherein the active gas is a single active gas, and the active gas comprises one or more selected from the group consisting of ammonia (NH₃), water vapor, carbon dioxide (CO₂), and hydrogen sulfide (H₂S).

3. The method as claimed in claim 1, wherein the active gas is a mixture gas of an active gas and an inert gas.

4. The method as claimed in claim 3, wherein the active gas comprises one or more selected from the group consisting of NH₃, water vapor, CO₂, and H₂S.

5. The method as claimed in claim 1, wherein the raw material comprises one or more selected from the group consisting of coal, coal tar pitch, coal tar, pitch coke, needle coke, phenolic resin, and coconut shells.

6. The method as claimed in claim 1, wherein the protective gas is nitrogen or argon.

7. The method as claimed in claim 4, wherein a ratio of flow rates of the active gas to the inert gas is in a range of 1: (0-10), and a total flow rate of the mixture gas is in a range of 20-100 milliliters per minute (mL min⁻¹).

8. An anode carbon material for the rate-type sodium-ion battery, prepared by utilizing the method as claimed in claim 1.

9. The anode carbon material of the rate-type sodium-ion battery as claimed in claim 8, wherein the anode carbon material of the rate-type sodium-ion battery is applied to sodium ion batteries.
